(19) United States
(12) Patent Application Publication
(10) Pub. No.: US 2001/0024533 A1
(43) Pub. Date: Sep. 27, 2001

(54) System & method for compositing of real and virtual images in a cinematographic puppetry production

(76) Inventor: Mitchell Kriegman, New York, NY (US)

Correspondence Address: Keith D. Nowak, Lieberman & Nowak, LLP, 350 Fifth Avenue, New York, NY, 10118, US

(21) Appl. No.: 09/760,568

(22) Filed: Jan. 16, 2001

Related U.S. Application Data
(63) Continuation-in-part of application No. 09/537,529, filed on Mar. 29, 2000.
Application No. 09/537,529 is a continuation-in-part of application No. 09/531,528, filed on Mar. 21, 2000.
(60) Provisional application No. 60/187,814, filed on Mar. 8, 2000.

(51) Int. Cl. G06K 9/36

(52) U.S. Cl. 382/284

(57) ABSTRACT

An improved cinematographic system for creation of a film and/or video productions wherein the action figures are puppets controlled by rods, manipulated by puppeteers, on a virtual production set. In the system and method of this invention, one or more production set props are positioned within the studio set between the puppeteers and the puppet. In order to avoid puppeteer cross of the set props while manipulation of the puppet, one or more real production set props, or components of real production set props, are key-colored to a background screen of the virtual production set, and thereby initially eliminated from the cinematographic reproduction of the real/action images of the action figures on the set. Thereafter, the real/action image is composited with at least one virtual image (virtual image of the production set prop and a virtual image of a background scene of the real/action image) to complete the cinematographic composition.

### CROSS-REFERENCE TO RELATED APPLICATION

This application is a continuation-in-part of copending Utility patent application, entitled AN IMPROVED METHOD AND APPARATUS FOR ENHANCED PUPPETRY OR SIMILAR TYPES OF PERFORMANCES UTILIZING A VIRTUAL SET, Ser. No. 09/531,528, filed on Mar. 29, 1999, which claims priority to Provisional Patent Application, entitled CGI Enhanced Puppetry Ser. No. 60/187,814, filed on Mar. 8, 2000.

### BACKGROUND OF THE INVENTION

1. Field of the Invention

This invention relates to a system and method for compositing, within a virtual environment, (a) an image frame, or image sequence of a real image, of an action sequence of a puppet and/or prop, within a virtual production set, with (b) a virtual image of a production set prop, or a component of a production set prop. The method further includes manipulating such real and virtual images so as to avoid a puppeteer cross of a production set prop set image during puppeteer manipulation of an action figure against a solid key-colored background; and, to a composite cinematographic image produced thereby.

2. Description of the Prior Art

Puppet shows have existed since antiquity in almost all countries of the world. In most forms, the puppet is manipulated either directly by hand, or by rods, strings or wires. Shadows of puppets are also sometimes used in a performance.

Perhaps the most advanced form of puppetry is Bunraku Puppetry. This form was originally developed at the end of the sixteenth century in Japan, and later took its name from Uemura Bunrakuken, a famous Japanese promoter in the early nineteenth century. Bunraku puppetry requires teams of three to four puppeteers to stand behind each puppet and move the arms, legs, mouth and body using rods and the puppeteer's hands. Normally, there is a chief puppeteer and two or more assistants to manipulate the puppet. Since three or four people handle the different parts of the puppet, life-like motion cannot be achieved without precision timing among the manipulators. For all motions, there are detailed rules and forms to be followed. No manipulator is allowed to act on their own.

In Japan, when operating this type of puppet on stage, the manipulators, as a rule, wear black gowns and black hoods. This signifies that the puppet is the main performer with the manipulator remaining behind the scenes and/or blended into the background. In the Japanese theatrical tradition, black costumes represent the invisible or nothingness.

In the present-day video and film environment, puppetry has and continues to survive and thrive. More specifically, notwithstanding the advances made in animation, puppetry continues to provide more life-like and realistic action imagery. This is achieved, in part, by the skill of the puppeteers, advanced camera techniques, the digital processing of the real images and the compositing of the real and virtual images in the finished video/film sequences. One of the filming techniques that has permitted the advancement of this art form, and its adaptation to modern imaging media, is known in the film industry as the “blue screen or key-color process”. More specifically, it is common practice to combine two or more images into a single scene. This technique of combining images is primarily achieved through use of a key-color process in which one image is photographed against a solid key-color background, (such as blue, green or grey) and the second image is substituted in place of that key-color background. It is also known that the background can be various other colors, and that the substitution can be made electronically, or through optical photographic techniques. This process is also known as the “keying” or the “Chroma key” process.

For example, it is commonplace to film an image of an announcer with a live camera (e.g. live image) in front of a blue screen, as a foreground image. Subsequently, a background image is generated in real time as a result of graphics processing performed by a high speed computer, and is super-imposed on the foreground image. The super-imposed portion of the background image and the foreground image is blanked out by the keying process and a composite image is obtained by fitting an object's image portion of the foreground image into the blank portion of the background image.

Although there are many advantages to using the standard key-color process, there are also several disadvantages. For example, the key-color process is generally an iterative process in which the end product, or combined file or video, is composited or “married in post” and is not viewable for evaluation until the entire process has been completed. As a result, film producers frequently view the end product and require changes to either the foreground or background portions, requiring that the entire sequence be “reshot”. Furthermore, because the process is post rendered in real-time, it is difficult to perform actual interaction between a moving puppet, for example, and the puppet's environment. The normal cycle for “blue screen” film production can require several iterations of this process.

The following patents are representative of the relevant art and thus summarized below, to the extent believed related to the subject matter of the instant invention.

U.S. Pat. No. 4,689,683 (to Efron., issued Aug. 25, 1987) discloses an image compositing system that permits real-time composition and editing of the composite image, specifically, a real image filmed against a blue screen background with a background image or fill image. An example of such a system is where the background information is provided by filming a miniature model rather than a life-size scene. According to Efron, the actors carry forward their activities before a blue screen and the background information is supplied by a separate camera filming the miniature model. The eventual composite is formed by scaling the respective background and foreground inputs to provide appropriate proportions between the foreground objects and the background objects. In the Efron system, the motion of the camera filming the foreground objects or actors performances must be duplicated by the camera filming the background scene information. That is to say if an actor in the foreground filming moves to the right and the camera moves with the actor to display that motion, there must be a corresponding motion of the camera filming the miniature model in the example given. It is the function of camera filming the foreground image to provide this coordinated or slaved motion of the secondary camera.

The compositing of the an action and background image in real-time permits the television or film producer to display and view the scene as it is occurs. In addition, the image processing enhancements provide by Efron, permit the television or film producer to view the resultant composited scene as it is actually occurring and, as appropriate, modify, enhance or embellish that image information for compositing into a final completed scene depiction. The importance of this advantage cannot be over emphasized to real-time editing of the composite image. Moreover, the ability to evaluate the composited scene in real time completely eliminates any iterative process under which the previous cinematography blue screen processes functioned and the concomitant delay and expenses.

U.S. Pat. No. 5,479,597 (to Fellous, issued Dec. 26, 1995) discloses a virtual camera having a parametric model of a real camera forming part of a filming system. According to Fellous, the synthetic (virtual) images are obtained through a graphics computer equipped with image synthesizing software; and, a dynamic coupling between the two cameras, real and virtual, securing perfect coherence between each real image and each virtual image of a series of images. This dynamic coupling permits the control of the virtual camera by the real camera and vice versa. The Fellous' virtual camera, thus, permits a real image to be combined with a virtual set, thereby the creation of a composite image of life-like quality with relative modest facilities and expenses.

U.S. Pat. No. 5,764,306 (to Steffano, issued Jun. 9, 1998) discloses a method that allows the real-time replacement of the designated background portion of an incoming video signal with an alternate background. The Steffano method utilizes the actual background image for reference and as the basis for determining the background and foreground elements within the image, with the end result being comparable to traditional blue-screen processes, (such as in the Chroma-key and Ultimatte technology), but requires only a personal computer, video camera and the software. In Steffano method, the reference background image can be any reasonably static scene with a sufficient and stable light source captured by the camera. The video data stream is then modified in real-time by comparisons against the reference background image and is then passed onto its original destination. Multiple signal-noise processing algorithms are applied in real-time against the signal to achieve a visually acceptable matte.

U.S. Pat. No. 5,949,433 (to Klotz, issued Sep. 7, 1999) discloses a method for processing image data, wherein real image data generated by a camera is combined with synthesized image data, comprising the steps of generating camera positional data representing characteristics of said camera, including an indication of zoom control; generating a synthesized image in response to said positional data; and adjusting the perceived focus of said synthesized image in response to zoom control adjustments, so as to effect a focusing difference between a portion of said real image and a portion of said synthesized image. The image processing capability of the Klotz method, thus, allows for the film director to project a virtual image into or out of a scene, in proportion to the objects within the other objects within scene.

U.S. Pat. No. 6,034,740 (to Mitsui, et al., issued Mar. 7, 2000) discloses a simple and inexpensive non-volatile memory storage device having a keying system, which include a recorded image of an object and recorded images of a plurality of the background images, each of which has a corresponding view angle of a view point in a three-dimensional space to be imaged, and a view position of the view point therein. The background image from the plurality of background images stored in the memory device can be selectively read according to the view angle and the view position preliminarily defined in accordance with the image of the object. A Chroma-keying composition is performed between the background image and the image of the object thereby producing a composite image.

According to Mitsui, et al., because his system includes a plurality of background images which are preliminarily stored on a memory device, (for example a simple disk array unit), the Chroma-keying composition of a composite image does use nor require advanced high-speed (high-performance) graphics processing and high-speed (high-performance) image processing. Consequently, a small computer such as a personal computer having an usual-performance (speed) CPU suffices as a controller for his system configuration. Therefore, Mitsui, et al., reports that both simplification of the system configuration and reduction in cost can be achieved without sophisticated skills and large-scale facilities.

Notwithstanding the advancements in image processing and composite image techniques, the application of such techniques to puppetry has yet to be applied to its full advantage. More specifically, the composting of a real and virtual image, such as has been used in film and video environments, has been traditionally applied to insert a background into a live image of an actor or announcer. The use of such techniques with live artists does not involve or otherwise conflict with any other actor or production set prop because the actor's movements are independent of another person or (in the puppetry example) a puppeteer. Where in fact a puppeteer is present on the production set, his presence, and the presence of manipulative rods, can and often cross or shadow other characters and props on the production set. The potential cross of another puppet or production set prop is particularly problematic where another puppet or prop is positioned between the puppeteer and his puppet. Up to now, the staging of action sequences involving puppet must be carefully staged to avoid action sequences where such crossing or shadowing would result. Such staging restrictions not only create special problems in staging of a scene, but also, in a number of instances, preclude puppeteers for imparting life-like action to the puppet. Thus, there is a continuing need to simplify the staging of action puppet sequences within a virtual studio production set, to enhance the life-like interaction of the puppet with common stage set props (e.g. bed, chair, etc.).

### OBJECTS OF THE INVENTION

It is the object of this invention to remedy the above as well as related deficiencies in the prior art.

More specifically, it is the principle object of this invention to provide a cinematographic system and method for enhancement of realistic action images of a puppetry video/film production by filming of live puppet action on a virtual studio set with real and virtual production set props, wherein one or more real set props, or a component of one or more real set props, is key-colored to blend it into a background screen of the virtual studio set and thereby eliminate it from appearance in the filmed scene or sequence of the live puppet action. The key-colored portion of the real set prop is then replaced by a virtual portion through computer manipulation.

It is another object of this invention to provide a cinematographic system and method for enhancement of realistic action images of a puppetry video/film production by filming of live puppet action on a virtual studio set with real and virtual production set props, wherein one or more real set props, or a component of one of more real set props, is key-colored to blend it into a background screen of the virtual studio set and thereby permit puppeteer manipulation of the puppet relative to such real key-colored real set props or key-colored components of said real set props, without crossing of the key-colored set prop or the key-colored components of the real set props, in the filmed scene or sequence of the puppet action.

It is still yet another object of this invention to provide a cinematographic system and method for enhancement of realistic action images of a puppetry video/film production by filming of live puppet action on a virtual studio set with real and virtual production set props wherein a filmed scene or sequence of the live puppet action, which includes a key-colored real set prop or a key-colored component of a real set prop, is composited with a virtual image of the key-colored virtual set prop or a virtual image of a key-colored component of a virtual set prop.

Additional objects of this invention include the composited real and virtual images prepared in accordance with the system and method of this invention.

### SUMMARY OF THE INVENTION

The above and related objects are achieved by providing a system and method for the adaptation of “blue screen” or “key-colored” cinematographic processes to advanced puppetry techniques, specifically, the compositing of real images with one or more virtual images of a real production set prop or a component of a real production set prop.

In one of the preferred embodiments of this invention, a realistic action image of a puppet is filmed on a virtual studio set with real production set props, wherein one or more real production set props, or a component of one of more real set props, is key-colored to the color of the puppeteer and to the background screen of the virtual studio, so as to blend the key-colored prop into a background screen of the virtual studio set. The resultant action image is, thereafter, composited with a virtual image of the key-colored set prop, or the key-colored component of the set prop. The original filming of the action image with key-colored props permits the puppeteer to manipulate the puppet without restriction by props which may be positioned between the puppeteer and puppet, and thereby eliminates puppeteer cross of the intervening prop. The restoration of the key-colored prop within the real/action image is effected by compositing the real/action image of the film scene/sequence with a virtual image of the key-colored set prop. The virtual image of the key-colored production set prop may be restored to the action image by compositing independently of other virtual images, or as a component of another virtual image.

In one of the preferred embodiments of this invention, the key-colored props can be included in a virtual image of a background scene, or, alternatively, each of the virtual image of the key-colored set prop and the virtual image of the background scene can be separately/sequentially composited with the real image separately. The particular advantage of the system and method of this invention, is to permit the use of a number of heretofore unavailable production set props in a cinematographic puppetry production, wherein puppeteer manipulation would cross the set prop, and, thus, cause in interference in the reproduction of the prop in the filming of real image.

In another of the preferred embodiments of this invention, the compositing of the image of real/action scene with the virtual image of the key-colored set prop is performed in real-time, and thereby permits the puppeteer to more precisely control the puppet's action relative to the key-colored prop; and, further permits more effective on-the-fly changes by the film director.

### BRIEF DESCRIPTION OF DRAWINGS

FIG. 1 depicts a virtual set used in the system and method of this invention.

FIG. 2 depicts the system and method for compositing the real image of FIG. 1 and a virtual background image.

FIG. 3 depicts a rear view of the virtual set of the instant invention from a puppeteer perspective

FIG. 4 depicts a virtual set in which the action figure and the puppeteers manipulate the puppet relative to a set prop (e.g. bed) in which a portion of the prop (e.g. headboard of the bed) is key-colored to the same color as the background screen and the puppeteers.

FIG. 5 depicts the system and method of this invention for compositing the real image of FIG. 4 with a virtual image of the key-colored headboard of the virtual set of FIG. 4.

FIG. 6 depicts the system and method for compositing the composite image of FIG. 5 and a virtual background image.

### DETAILED DESCRIPTION OF THE INVENTION INCLUDING PREFERRED EMBODIMENTS

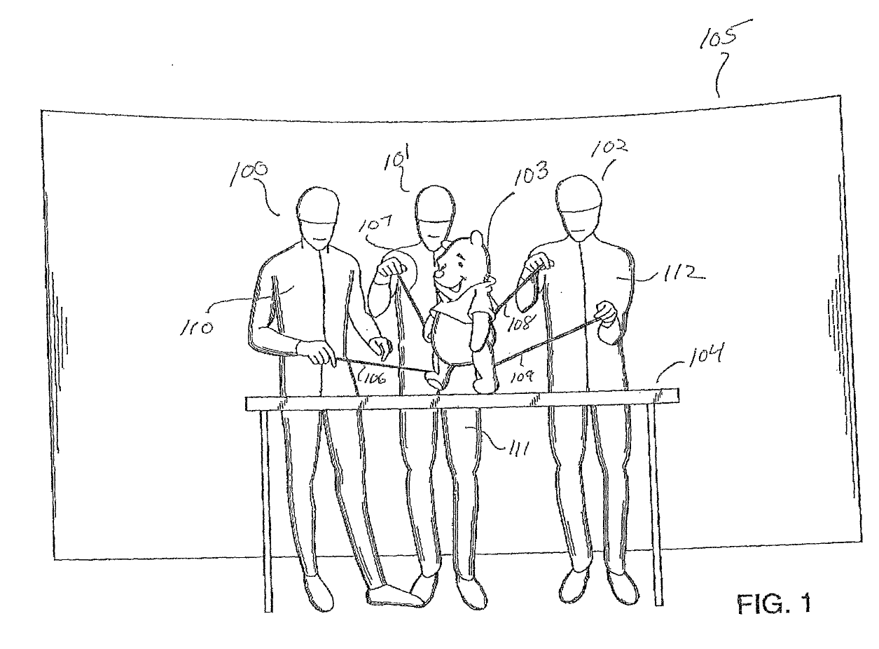

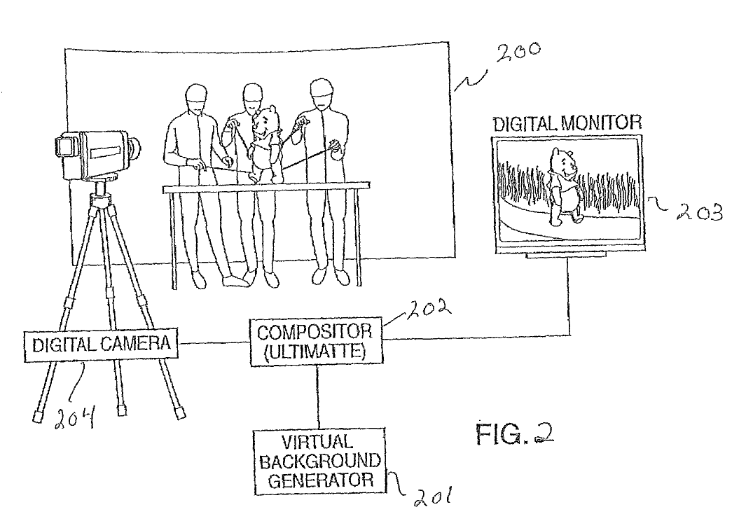

The figures which appear herein, specifically, FIGS. 1, 2 & 3, are taken from commonly assigned Utility patent application Ser. No. 09/531,529, filed on Mar. 29, 2999. The cinematographic image processing techniques (e.g. image compositing) referenced herein both in the Background of the Invention, and in the description that follows, are more fully described in U.S. Pat. No. 5,515,109 (to Vlahos, et al. May 7, 1996), U.S. Pat. No. 5,742,354 (to Vlahos, et al. Apr. 21, 1998), U.S. Pat. No. 5,831,685 (to Vlahos, et al. Nov. 3, 1998), and U.S. Pat. No. 5,971,544 (to Perry, issued Oct. 26, 1999) which are herein incorporated by reference in their entirety.

Turning now to the specific embodiments of the invention illustrated herein, FIG. 1, depicts a virtual set in accordance with one embodiment of the invention directed to puppetry. More specifically, FIG. 1 depicts Bunraku puppetry wherein puppet 103 is Winnie The Pooh and three (3) puppeteers/manipulators, 100, 101 and 102 operate the puppet in a life-like manner. The puppet rests on table 104, and the background consists entirely of key-color background screen 105. Rods 106-109, etc., are used by the puppeteers to control all movements of puppet 103.

Advantageously, as shown in FIG. 1, the puppeteers wear head-to-foot highly reflective keyable color suits, 110, 111 and 112. The suits include a hood, gloves, foot coverings and a piece of gauze, or similar material, over the eyes. The key-color of the material completely covering the puppeteers exactly matches the color of key-color screen 105. Similarly, table 104, rods 106-109, the studio floor, and all other objects in the set, except puppet 103, will exactly match the color of key-color screen 105.

In contrast, puppet 103 is designed and built with special care not to include colors in the body of the puppet that would match the key-color. Special care is taken to insure that puppet 103 does not include the key-color in its coloring or shading. Additional cautionary steps are required to avoid the crossing (shadowing) of any puppet feature, or set prop, with a key-colored rod (rods 106-109), or with a part of puppeteer's body. As more fully set forth herein, this invention avoids the consequences of crossing, and permits more life-like puppet action, because it permits puppet manipulation without restriction by props which may be positioned between the puppeteer and puppet, and thereby eliminates puppeteer cross of the intervening prop. Thus, the use key-colored set props in the real/action scenes and sequences and the later compositing of the real/action scenes and sequences with a virtual image of the key-colored prop, permits greater puppeteer freedom of movement and interaction between the puppet and its environment, resulting in a more animated puppet and a more life-like action image.

Key-color screen 105 is typically in the shape of a hard cyclorama, which is built and painted a reflective keyable color. This color could be reflective green or blue, or even a highly reflective gray. A cyclorama is essentially a high wall that is curved at the base to eliminate any hard lines in the set that can cause shadows. Ideally, when filming the action of puppet 103, the “shoot” is into the curved corner of two cyclorama walls.

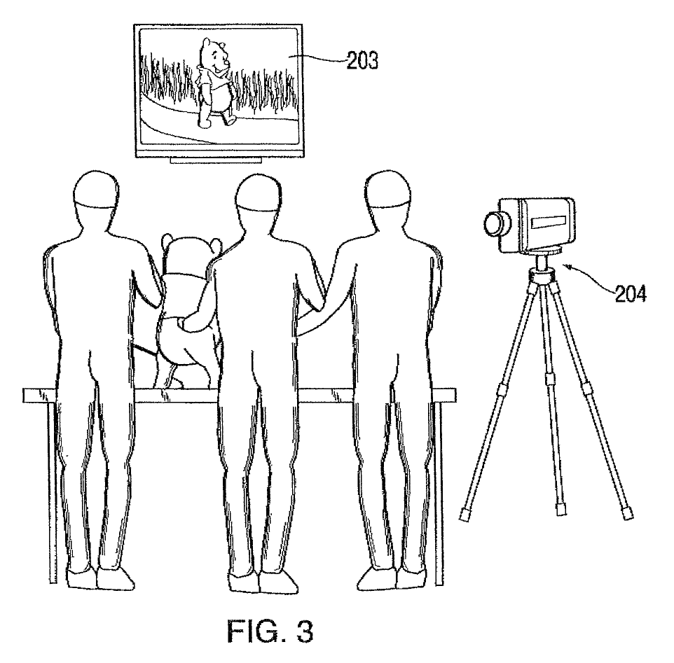

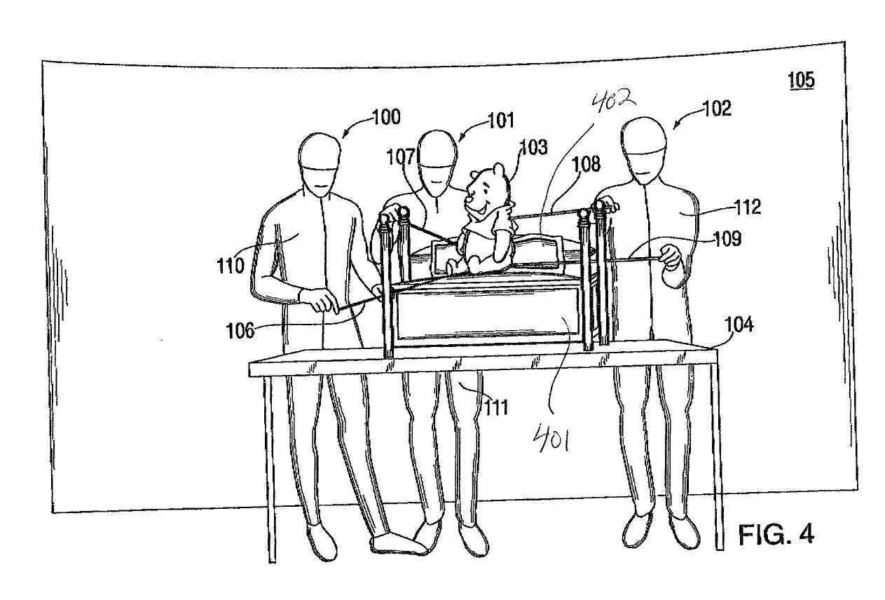

Table 104 is designed to be approximately thirty-six (36) inches high, but, of course, can be in various shapes and forms and multiple tables can be used. All tables to be used on the set can be adjusted for height and size, and would be painted the same keyable color as screen 105. As more fully described in reference to FIGS. 3, 4 & 5, the table can include one of more set props, and the puppet can be placed and/or manipulated on or around the set props.

This table and similar platforms are used by the puppeteers to simulate where the ground would be in the virtual set. The table gives the puppets, when they walk within the virtual set, something real to step on so the action of walking is believable. These tables can also have a light source within the table to create a glow from below in order to further eliminate shadows where the characters touch the table surface.

The lighting strategies are very important to the success of the inventive technique. Successfully marrying two images in real time—the live puppets and a virtual background—without shadows or key-color problems, is the measure of success for the technical process. Suffused lighting that creates an overall lack of shadows is the base of the lighting techniques. The use of the glowing tables is a second key to eliminating shadows. The use of ultraviolet light is another technique that successfully places light in all shadow areas that the camera does not read because it does not register that kind of light. Such lighting strategies are known, have been used with prior art key-color schemes, and will not be described herein in further detail.

Since all objects shown on the set in FIG. 1, except for puppet 103, are the exact same key-color as screen 105, it is to be understood that all such objects can be eliminated from a shot taken of the set shown in FIG. 1 utilizing known key-color techniques. Advantageously, in this way, puppet 103 will appear autonomous, free and independent of control of the puppeteers in the final filmed scene.

Referring now to FIG. 2, there is illustrated the manner in which a shot is actually taken of the set shown in FIG. 1. Set 200 is the same set as shown in FIG. 1. More specifically, a shot of the performance on the set is taken with digital camera 204, and the digital output of camera 204 is sent to video compositor 202. It is, of course, understood that a standard film or video camera could be used in place of a digital camera, with the performance being digitized in a well-known manner. This video compositor can be, for example, an Ultimatte™ device. The Ultimatte™ compositing technique has been used in video compositing for 20 years, is well-known in the art, and will not be described in further detail herein.

The virtual background to be combined with the actual performance, taken by digital camera 204, is generated by virtual background generator 201. Virtual backgrounds can be designed within a computer in any variety of virtual software programs. Elset and Maya are two examples, but this software is always changing and being innovated. What is key, is that the virtual system is a real time system that streams the set in real time so that the studio video switching system can composite both the live puppet image with the computerized virtual sets simultaneously. Typically, an Onyx (a high capacity, very fast computer) is used for this purpose, but there are several real time virtual composite systems on the market, all with different degrees of ease of use. The studio itself, to be used with the invention, as far as control room equipment is concerned, can be conventional, requiring tape machines, switchers and all the usual elements although maximized for good key-color technique.

After the outputs of digital camera 204, and virtual background generator 201 are combined in video compositor 202, the combined output is sent to digital monitor 203. Advantageously, what is shown on digital monitor 203 is only the movements of puppet 103 superimposed on the virtual background generated by virtual background generator 201. The puppeteers, which were controlling the puppet on the actual set, shown in FIG. 1, are completely eliminated from the final product, and only the puppet and the virtual background are visible.

FIG. 3 illustrates a rear view of the set in FIG. 1 showing what the puppeteers see while manipulating puppet 103. As indicated, the puppeteers can readily watch the finished product on monitor 203, while the action is taking place. Most importantly, since the final image is generated and composited in real time as the actual performance is shot by digital camera 204, the puppeteers can see the composited final image on the monitor in real time. Therefore, the puppeteers have the complete ability to interact with their environment, including any virtual and real objects in that environment and each other.

Referring now to FIG. 4, the film sequence of FIGS. 1-3 is now repeated with real set props, including specifically, a real bed 401 which has the headboard 402 key-colored to the same reflective color of key-color screen 105. In the staging of this film sequence, a series of real props, including bed 401 is placed upon table 104 of the virtual set. The bed is positioned between puppeteers 100, 101 & 102 and puppet 103. In order to impart realistic action/motion (e.g. the puppet bouncing or rolling around on the bed), the manipulation of the puppet will necessarily result in rod 106, 107, 108 or 109 to cross of headboard 402 or bed 401. In the virtual set illustrated in this FIG. headboard 402 is key-colored to the color of the reflective screen 105.

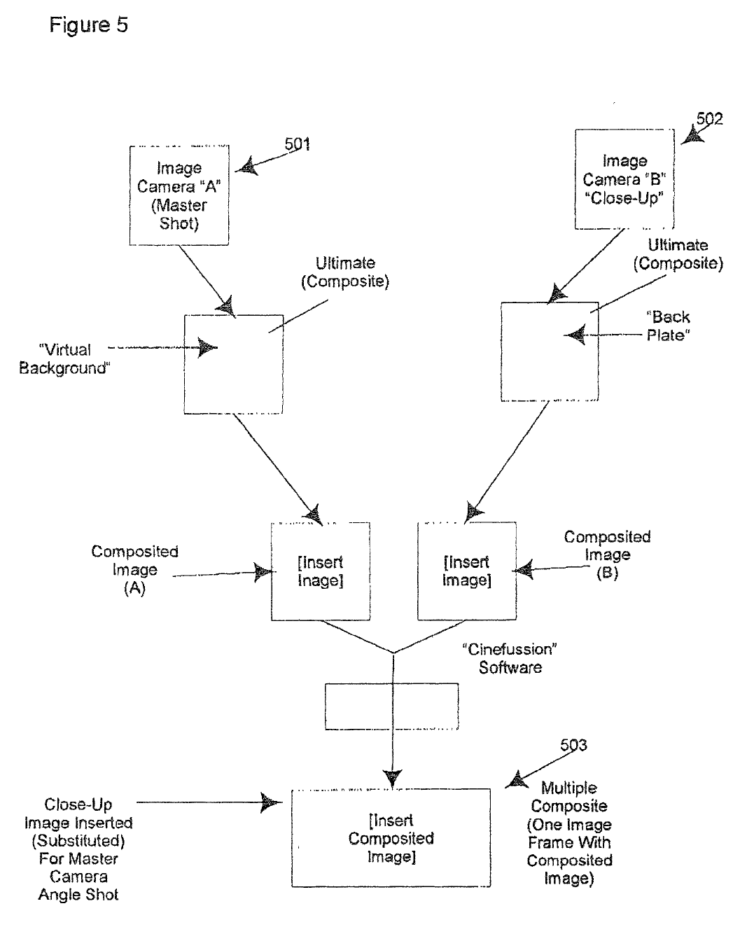

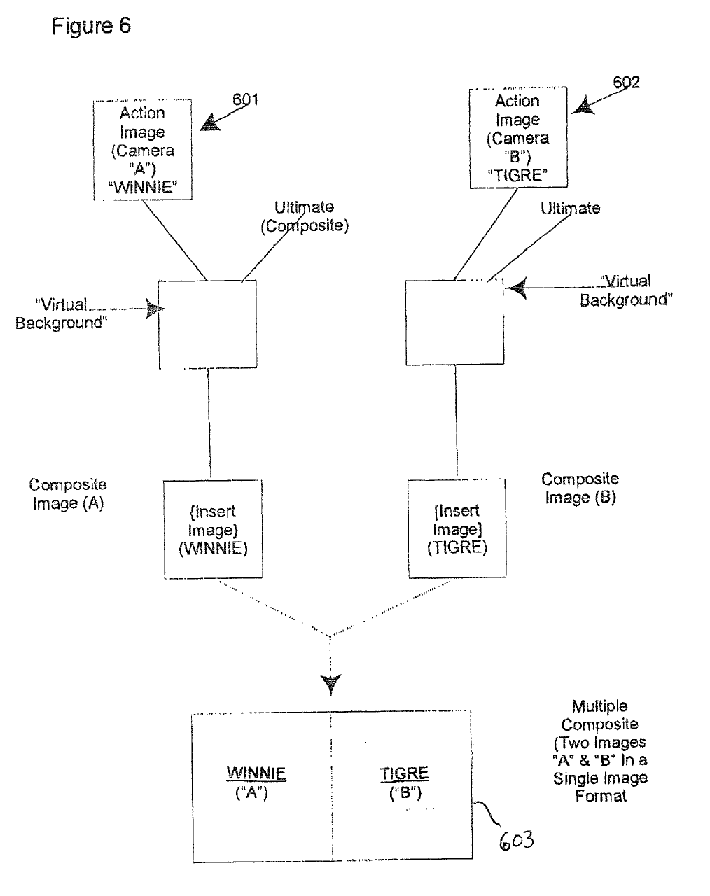

Referring now to FIG. 5, the compositing process, as shown and discussed above in reference to FIG. 2, is now applied to combine the real/action image of the FIG. 4 with one or more virtual images. For example, the real/action image of FIG. 4 can now be composited with a virtual image of the key-colored headboard 401; and, alternatively, as shown in FIG. 6, with a background image that includes, as a virtual image component thereof, a virtual image of key-colored headboard 401.

In each of FIGS. 5 & 6, the puppeteers can observe the composited images, in real time, in a video monitor positioned in front of the virtual set (as shown in FIG. 3).

The description appearing herein has, for simplicity of illustration and understanding, been made in reference to the accompanying figures, which depict the coordinated manipulation of a puppet by a number of puppeteers; and, the subsequent compositing of the real/action image with one or more virtual images. Notwithstanding, it is understood that further compositing of the images attained herein is not only possible but also contemplated within the scope of this invention, specifically, the compositing of the composite image of FIG. 2 and/or FIG. 5 with yet another real/action image of live actors or with a animated image of other characters.

What is claimed is:

1. In a cinematographic system for creation of a film and/or video productions wherein the action figures are puppets controlled by rods, manipulated by puppeteers, on a virtual production set, the improvement comprising:
A. A key-colored background screen;
B. A production set prop wherein at least a portion of said set prop is key-colored to said background screen, wherein said set prop is positioned between a puppet and its puppeteers;
C. Means for reproducing, by cinematographic techniques, against the background of the key-color screen, a real/action image, or a film sequence of real/action images, of a puppet that is manipulated by a plurality of puppeteers, said puppeteers being clothed in a material which is also key-colored to said background screen;
D. Means for real time compositing said real/action image and a virtual image of said key-colored set prop either alone or in combination with a virtual of a background; and
E. Means for display of said composited image.

2. In a method for the production of an action cinematographic composition wherein the action figures are puppets controlled by rods, manipulated by puppeteers, on a virtual production set, the improvement comprising:
A. Providing
(1). A key-colored background screen;
(2). A production set prop wherein at least a portion of said set prop is key-colored to said background screen wherein said set prop is positioned between a puppet and its puppeteers;;
(3). Means for reproducing, by cinematographic techniques, against the background of the key-color screen, a real/action image, or a film sequence of real/action images, of a puppet that is manipulated by a plurality of puppeteers, said puppeteers being clothed in a material which is also key-colored to said background screen;
(4). Means for real time compositing said real/action image and a virtual image of said key-colored set prop either alone or in combination with a virtual of a background; and
(5). Means for display of said composited image.
B. Combining, in real-time, each of said real/action image and each of said virtual images so as to form a composite of said real/action image and said virtual images;
C. Displaying said composite image

3. In an cinematographic composition wherein the action figures are puppets controlled by rods, manipulated by puppeteers, on a virtual production set, the improvement comprising:
A cinematographic image composite comprising a real/action image recorded against a key-colored background screen, and at least one virtual image wherein said virtual image is selected from the group consisting of a production set prop, a component of a production set prop or a background scene for said real/action image.

4. The improved cinematographic composition of claim 3, wherein said real/action image comprises a puppet manipulated by puppeteers key-colored to said key-colored background screen of said virtual production set.

5. The improved cinematographic composition of claim 3, wherein said real/action image comprises a puppet manipulated by puppeteers key-colored to said key-colored background screen of said virtual production set, and said production set props are located within said production set between said puppeteers and said puppet.
